(19) United States
(12) Patent Application Publication
(10) Pub. No.: US 2025/0308072 A1
(43) Pub. Date: Oct. 2, 2025

(54) METHOD AND ELECTONIC DEVICE FOR ADAPTIVE STREAMING

(71) Applicant: MEDIATEK INC., Hsinchu City (TW)

(72) Inventor: Yi-Ming HUANG, Hsinchu City (TW)

(21) Appl. No.: 18/616,749

(22) Filed: Mar. 26, 2024

(51) Int. Cl. G06T 9/00; G06T 3/40; G06T 7/00; G06V 20/40

(52) U.S. Cl. CPC G06T 9/00; G06T 3/40; G06T 7/0002; G06V 20/44; G06T 2207/30168; G06T 2207/30252; G06V 2201/07

(57) ABSTRACT

A method for adaptive streaming is provided. The method includes the following steps. A plurality of images are received from at least one camera. The images are encoded in a first format. It is detected that that there has been an event based on the images. The images are encoded in a second format in response to detecting that there has been an event. The images from a first predetermined period before the event is detected to a second predetermined period after the event is over are stored into a non-volatile memory. The images encoded in the second format are higher quality than the images encoded in the first format.

### FIELD OF THE INVENTION

The present invention relates to image processing method, and, in particular, to a method and an electronic device for adaptive streaming.

### DESCRIPTION OF THE RELATED ART

Sentry mode is a video surveillance and event-action mechanism that uses camera lenses around a vehicle. Sentry mode needs to take into account both the video quality and the power consumption of real-time image analysis and video encoding. The video quality affects the clarity of images and the smoothness of object movement. The power consumption of real-time image analysis and video encoding affects the battery level, and hence the duration of the sentry mode.

In general, the higher the quality of the video recording, the higher the power consumption, and the greater the power consumption, the shorter the duration of sentry mode. The lower the quality of the video recording, the lower the power consumption and the longer the duration of sentry mode, but the image may be blurry, or the objects in the image may not move smoothly, which is not conductive to a proper analysis of subsequent incidents. How to balance the video quality and the power consumption of real-time image analysis and video encoding has become an important issue.

### BRIEF SUMMARY OF THE INVENTION

An embodiment of the present invention provides a method for adaptive streaming. The method includes the following steps. A plurality of images are received from at least one camera. The images are encoded in a first format. It is detected that there has been an event based on the images. The images are encoded in a second format in response to detecting that there has been an event. The images encoded in the second format are higher quality than the images encoded in the first format.

According to the method described above, the step of encoding images from the first format to the second format includes the following step. The images are encoded by changing the resolution, frame rate, or both, of the images.

The method further includes the following step. The images are recovered to encode the images in the first format after the event is over.

The method further includes the following steps. The images encoded in the first format are stored into a volatile memory before detecting that there has been an event. The images encoded in the first format are stored into the volatile memory after the event is over. The images from a first predetermined period before the event is detected to a second predetermined period after the event is over are stored into a non-volatile memory.

According to the method described above, the images received from said camera originally have a third format. The method further includes the following step. The images that are in a fourth format are received from said camera in response to detecting that there has been an event. The images in the fourth format are higher quality than the images in the third format.

The method further includes the following steps. It is detected that there is an extension event after the event is detected. The images are encoded in a fifth format in response to detecting that there has been an extension event after the event is detected. The images encoded in the fifth format are a lower quality than the images encoded in the second format.

According to the method described above, the step of detecting that there has been an extension event after the event is detected includes the following step. It is determined that there has been an extension event based on the power consumption of the vehicle, the battery level of the vehicle, noises around the vehicle, the environment around the vehicle, or a combination thereof, after the event is detected.

The method further includes the following step. The images that are in a sixth format are received from said camera in response to detecting that there has been an extension event. The images in the sixth format are higher quality than the images in the fourth format.

An embodiment of the present invention also provides an electronic device. The electronic device includes an image signal processor (ISP), a processor, and an encoder. The ISP receives a plurality of images from at least one camera. The processor is electrically connected to the ISP, executes a moving object detection algorithm, and detects that there has been an event based on the images. The encoder is electrically connected to the ISP and the processor, encodes the images in a first format, and encodes the images in a second format when the processor detects that that there has been an event. The images encoded in the second format are higher quality than the images encoded in the first format.

According to the electronic device described above, the encoder encodes images from the first format to the second format by changing the resolution, frame rate, or both, of the images.

According to the electronic device described above, the encoder recovers to encode the images in the first format after the event is over.

According to the electronic device described above, the processor stores the images encoded in the first format into a volatile memory before detecting that there has been an event, and stores the images encoded in the first format into the volatile memory after the event is over. The processor stores the images from a first predetermined period before the event is detected to a second predetermined period after the event is over into a non-volatile memory.

According to the electronic device described above, the images received from said camera originally have a third format. The ISP receives the images that are in a fourth format from said camera when the processor detects that there has been an event. The images in the fourth format are higher quality than the images in the third format.

According to the electronic device described above, the processor detects that there is an extension event after the event is detected; the encoder encodes the images with a fifth format when the processor detects that there has been an extension event after the event is detected. The images encoded in the fifth format are a lower quality than the images encoded in the second format.

According to the electronic device described above, the processor determines that there has been an extension event based on the power consumption of the vehicle, the battery level of the vehicle, the noises around the vehicle, the environment around the vehicle, or a combination thereof, after an event is detected.

According to the electronic device described above, the ISP receives the images that are in a sixth format from said camera when the processor detects that there has been an extension event. The images in the sixth format are higher quality than the images in the fourth format.

### BRIEF DESCRIPTION OF THE DRAWINGS

The present invention can be more fully understood by reading the subsequent detailed description and examples with references made to the accompanying drawings, wherein:

FIG. 1 is a flow chart of a method for adaptive streaming in accordance with some embodiments of the present invention.

FIG. 2 is a flow chart of a method for adaptive streaming in accordance with some embodiments of the present invention.

FIG. 3 is a flow chart of a method for adaptive streaming in accordance with some embodiments of the present invention.

FIG. 4 is a schematic diagram of an electronic device 400 in accordance with some embodiments of the present invention.

FIG. 5 is a schematic diagram of an electronic device 500 in accordance with some embodiments of the present invention.

FIG. 6 is a schematic diagram of an electronic device 600 in accordance with some embodiments of the present invention.

FIG. 7 is a schematic diagram of a method for consistent streaming in the prior art.

FIG. 8 is a schematic diagram of a method for adaptive streaming in accordance with some embodiments of the present invention.

FIG. 9 is a schematic diagram of a method for adaptive streaming in accordance with some embodiments of the present invention.

FIG. 10A is a comparison diagram of power consumption between the method for adaptive streaming of the present invention and the method for consistent streaming in the prior art.

FIG. 10B is a comparison diagram of a battery level loss between the method for adaptive streaming of the present invention and the method for consistent streaming in the prior art corresponding to FIG. 10A.

FIG. 11A is a comparison diagram of a streaming quality between the method for adaptive streaming of the present invention and the method for consistent streaming in the prior art.

FIG. 11B is a comparison diagram of a battery level loss between the method for adaptive streaming of the present invention and the method for consistent streaming in the prior art corresponding to FIG. 11A.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present invention.

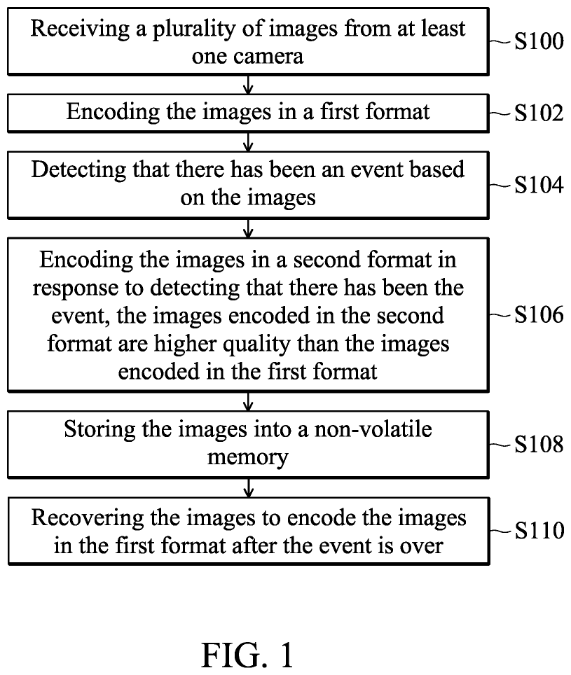

FIG. 1 is a flow chart of a method for adaptive streaming in accordance with some embodiments of the present invention. As shown in FIG. 1, the method for adaptive streaming includes the following steps. A plurality of images are received from at least one camera (step S100). The images are encoded in a first format (step S102). It is detected that that there has been an event based on the images (step S104). The images are encoded in a second format in response to detecting that there has been an event. The images encoded in the second format are higher quality than the images encoded in the first format (step S106). The images from a first predetermined period before the event is detected to a second predetermined period after the event is over are stored into a non-volatile memory (step S108). It is recovered to encode the images in the first format after the event is over. (step S110). In some embodiments, the non-volatile memory may be a disk or a flash memory, but the present invention is not limited thereto.

In step S100, said camera is disposed on a vehicle. In some embodiments, the images received from said camera originally have a format with a resolution of 4K and a frame rate of 60 fps, but the present invention is not limited thereto. In steps S102 and S106, the step of encoding images from the first format to the second format includes the following step. The images are encoded by changing the resolution, frame rate, or both, of the images. For example, in step S102, the method for adaptive streaming of the present invention encodes the images with a resolution of 2K and a frame rate of 5 fps. In step S106, the method for adaptive streaming of the present invention encodes the images at a resolution of 4K and a frame rate of 60 fps in response to detecting that there has been an event. That is, the images encoded at a resolution of 4K and a frame rate of 60 fps are higher quality than the images encoded at a resolution of 2K and a frame rate of 5 fps.

In step S104, when the method for adaptive streaming of the present invention detects that there is motion in the current frame of the images and determines that the motion was caused by a human, the method for adaptive streaming of the present invention determines that there has been an event. In step S108, the first predetermined period before the event is detected may be 2 minutes, and the second predetermined period after the event is over may be 2 minutes, but the present invention is not limited thereto. In step S110, the method for adaptive streaming of the present invention recovers to encode the images at a resolution of 2K and a frame rate of 5 fps.

In some embodiments, when the method for adaptive streaming of the present invention detects that there has been no event based on the images, the method for adaptive streaming of the present invention keeps encoding the images in the format which is the same as that in step S102, for example, the format with a resolution of 2K and a frame rate of 5 fps. In some embodiments, when the method for adaptive streaming of the present invention detects that there is no motion in the current frame of the images, or detects motion in the current frame of the images and determines that the motion was not caused by a human, the method for adaptive streaming of the present invention determines that there has been no event. In some embodiments, the method for adaptive streaming of the present invention stores the images encoded in the format which is the same as that in step S102, for example, the format with a resolution of 2K and a frame rate of 5 fps, into a volatile memory before detecting that there has been an event. The volatile memory may be a dynamic random access memory (DRAM), but the present invention is not limited thereto. In some embodiments, the method for adaptive streaming of the present invention stores the images encoded in the first format, for example, the format with a resolution of 2K and a frame rate of 5 fps, into the volatile memory after the event is over.

In some embodiments, when the method for adaptive streaming of the present invention detects that there is no motion in the current frame of the images, or detects motion in the current frame of the images and determines that the motion was not caused by a human, the method for adaptive streaming of the present invention determines the event is over.

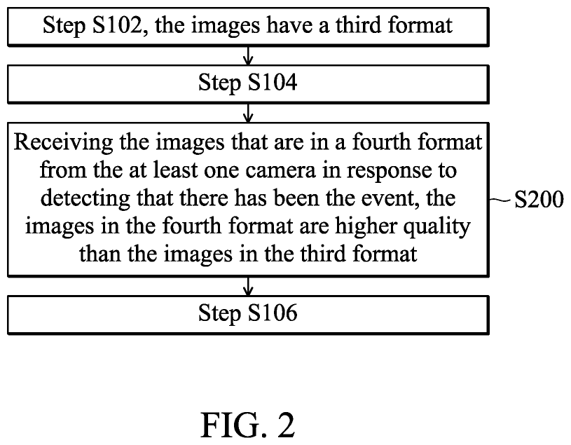

FIG. 2 is a flow chart of a method for adaptive streaming in accordance with some embodiments of the present invention. As shown in FIG. 2, after steps S100, S102 and S104 in FIG. 1 are executed and the images received in step S100 originally have a third format, for example, a format with a resolution of 2K and a frame rate of 5 fps, the method for adaptive streaming of the present invention receives the images that are in a fourth format, for example, a format with a resolution of 4K and a frame rate of 60 fps, from said camera in response to detecting that there has been an event (step S200). That is, the images in the fourth format are higher quality than the images in the third format. In detail, after steps S100, S102 and S104 in FIG. 1 are executed, said camera which is format changeable receives a control signal to changes the format of its output images from the third format to the fourth format. After step S200 is executed, the method for adaptive streaming of the present invention may perform the subsequent step, such as step S106 in FIG. 1, but the present invention is not limited thereto.

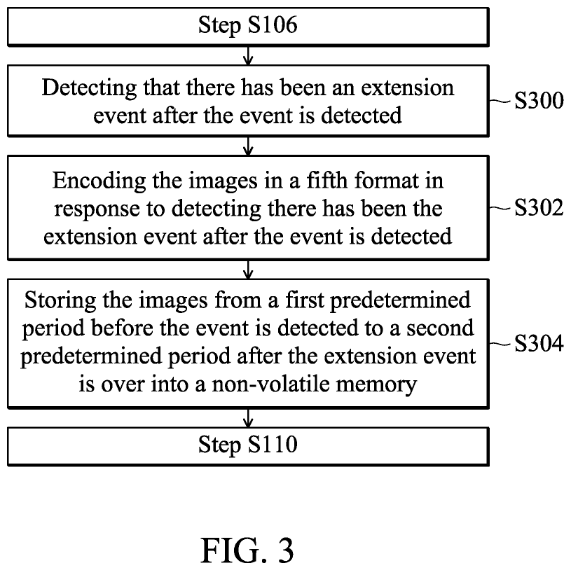

FIG. 3 is a flow chart of a method for adaptive streaming in accordance with some embodiments of the present invention. As shown in FIG. 3, after step S106 in FIG. 1 is executed, the method for adaptive streaming of the present invention detects that there is an extension event after the event is detected (step S300), encoding the images with a fifth format, for example, a format with a resolution of 2K and a frame rate of 30 fps, in response to detecting that there has been an extension event after the event is detected (step S302), and stores the images from a first predetermined period before the event is detected to a second predetermined period after the extension event is over into a non-volatile memory (step S304). In some embodiments, the first predetermined period before the event is detected may be 2 minutes, and the second predetermined period after the extension event is over may be 2 minutes, but the present invention is not limited thereto.

In some embodiments of step S300, the method for adaptive streaming of the present invention determines that there has been an extension event based on the power consumption of the vehicle, the battery level of the vehicle, the noises around the vehicle, the environment around the vehicle, or a combination thereof, after an event is detected. For example, when the battery level of the vehicle is lower than a threshold after the event is detected, the method for adaptive streaming of the present invention determines that there has been an extension event. In some embodiments of step S304, when the method for adaptive streaming of the present invention detects that there is no motion in the current frame of the images, or detects motion in the current frame of the images and determines that the motion was not caused by a human, the method for adaptive streaming of the present invention determines the event and the extension event is over. After step S304 is executed, the method for adaptive streaming of the present invention may perform the subsequent step, such as step S110 in FIG. 1, but the present invention is not limited thereto.

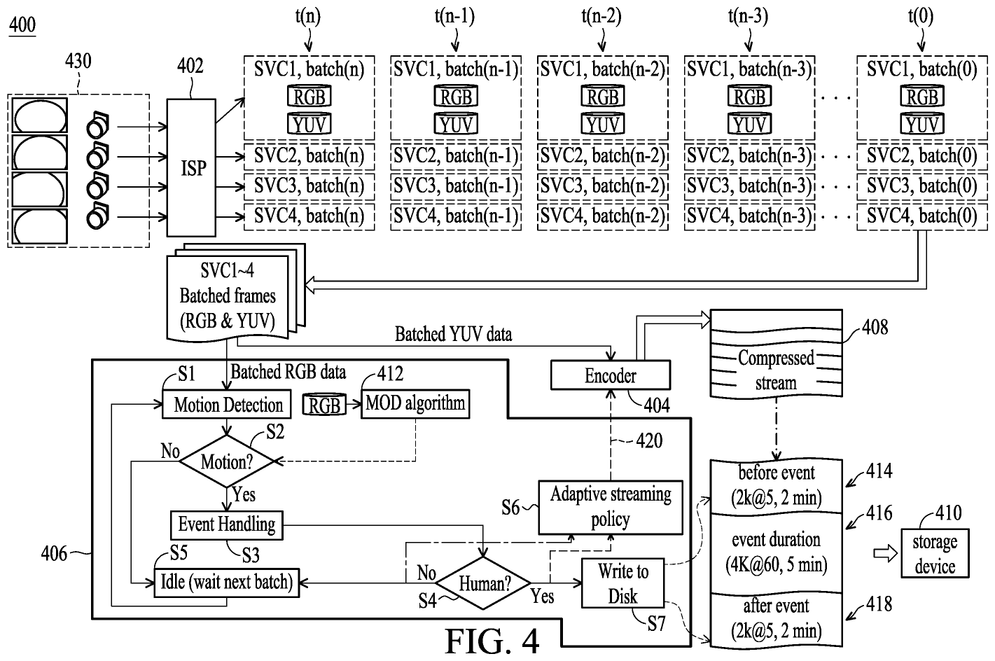

FIG. 4 is a schematic diagram of an electronic device 400 in accordance with some embodiments of the present invention. As shown in FIG. 4, the electronic device 400 includes an image signal processor (ISP) 402, an encoder 404, a processor 406, a DRAM 408, a storage device 410, and cameras 430. The ISP 402 receives a plurality of images from cameras 430. In some embodiments, the cameras 430 include a camera SVC1, a camera SVC2, a camera SVC3, and a camera SVC4, but the present invention does not limit the number of cameras included in the cameras 430. For example, at time point t(0), the ISP 402 receives the images from the cameras SVC1, SVC2, SVC3, and SVC4 to generate data SVC1_batch(0), data SVC2_batch(0), data SVC3_batch(0), and data SVC4_batch(0), each of those includes batched RGB data and batch YUV data. At time point t(n−3), the ISP 402 receives the images from the cameras SVC1, SVC2, SVC3, and SVC4 to generate data SVC1_batch(n−3), data SVC2_batch(n−3), data SVC3_batch(n−3), and data SVC4 batch(n−3), each of those includes batched RGB data and batch YUV data.

Similarly, at time point t(n−2), the ISP 402 receives the images from the cameras SVC1, SVC2, SVC3, and SVC4 to generate data SVC1_batch(n−2), data SVC2_batch(n−2), data SVC3_batch(n−2), and data SVC4_batch(n−2), each of those includes batched RGB data and batch YUV data. At time point t (n−1), the ISP 402 receives the images from the cameras SVC1, SVC2, SVC3, and SVC4 to generate data SVC1_batch(n−1), data SVC2_batch(n−1), data SVC3_batch(n−1), and data SVC4_batch(n−1), each of those includes batched RGB data and batch YUV data. At time point t (n), the ISP 402 receives the images from the cameras SVC1, SVC2, SVC3, and SVC4 to generate data SVC1_batch(n), data SVC2_batch(n), data SVC3_batch(n), and data SVC4_batch(n), each of those includes batched RGB data and batch YUV data, wherein n is a positive integer.

The processor 406 is electrically connected to the ISP 402, executes a moving object detection algorithm 412, and detects that there has been an event based on the images. In detail, the processor 406 receives batched RGB data for event detection and executes motion detection (S1). The moving object detection algorithm 412 executed by the processor 406 determines whether there is motion based on the images received from the cameras 430 (S2). If the processor 406 determines that there is motion (Y), that is, the processor 406 detects motion in the current frame of the images, the processor 406 executes event handling (S3) for subsequent event determination. After that, the processor 406 determines whether the motion was caused by a human (S4). If the processor 406 determines that the motion was caused by a human (Y), the processor 406 determines that there has been an event to execute an adaptive streaming policy (S6), and send a control signal 420 to the encoder 404. If the processor 406 determines that the motion was caused by a human (Y), the processor 406 writes the images from a first predetermined period before the event is detected to a second predetermined period after the event is over into a disk (S7), for example, the storage device 410. In some embodiments, the storage device 410 is a non-volatile memory.

If the processor 406 detects that there is no motion based on the images (N), the processor 406 may enter to an idle mode and wait for next batched RGB data (S5). If the processor 406 determines that the motion was not caused by a human (N), the processor 406 may enter to the idle mode and wait for next batched RGB data (S5). In some embodiments, if the processor 406 determines that the motion was not caused by a human (N), the processor 406 may also execute the adaptive streaming policy (S6), and send the control signal 420 to the encoder 404. After receiving the control signal 420 from the processor 406, the encoder 404 may encode the images with lower resolution and/or lower frame rate based on the control signal 420 when the processor 406 determines that the motion was not caused by the human.

The encoder 404 is electrically connected to the ISP 402 and the processor 406, encodes the images in a first format originally, and encodes the images in a second format after receiving the control signal 420 from the processor 406. For example, the first format may be the format with a resolution of 2K and a frame rate of 5 fps, and the second format may be the format with a resolution of 4K and a frame rate of 60 fps, but the present invention is not limited thereto. In detail, the encoder 404 receives batched YUV data from the ISP 402 for video encoding. After receiving the control signal 420 from the processor 406, the encoder 404 encodes the batched YUV data from using the first format to using the second format. In some embodiments, the encoder 404 all the time stores the batched YUV data corresponding to the images into the DRAM 408. In detail, the encoder 404 may compress the batched YUV data to generate compressed stream, and stores the compressed stream in the DRAM 408.

In some embodiments, when the encoder 404 receives the control signal 420 from the processor 406, the compressed stream corresponding to the images from the first predetermined period before the event is detected to the second predetermined period after the event is over in the DRAM 408 may be stored to the storage device 410. For example, data blocks 414, 416, and 418 may be stored to the storage device 410. The data block 414 includes the compressed stream corresponding to the images from the first predetermined period before the event is detected to the time point when the event is detected. The data block 416 includes the compressed stream corresponding to the images from the time point when the event is detected to the time point when the event is over. The data block 418 include the compressed stream corresponding to the images from the time point when the event is over to the second period after the event is over.

For example, the data block 414 includes the compressed stream corresponding to the images having 2 minutes duration and encoded at a resolution of 2K and a frame rate of 5 fps. The data block 416 includes the compressed stream corresponding to the images having 5 minutes duration and encoded at a resolution of 4K and a frame rate of 60 fps. The data block 418 includes the compressed stream corresponding to the images having 2 minutes duration and encoded at a resolution of 2K and a frame rate of 5 fps. In some embodiments, the DRAM 408 may store the compressed stream corresponding to the images having no longer than 5 minutes duration. The present invention does not limit the number of compressed streams stored in the DRAM 408. If the compressed streams stored by the encoder 404 totally have the duration longer than 5 minutes, the compressed streams stored in the DRAM 408 may be overwritten. That is, the old compressed stream may be overwritten by the new compressed stream, but the present invention is not limited thereto. In some embodiments, each of the data blocks 414, 416 and 418 may include one compressed stream or multiple compressed streams. One compressed stream may be decompressed and decoded as a video file for subsequent application.

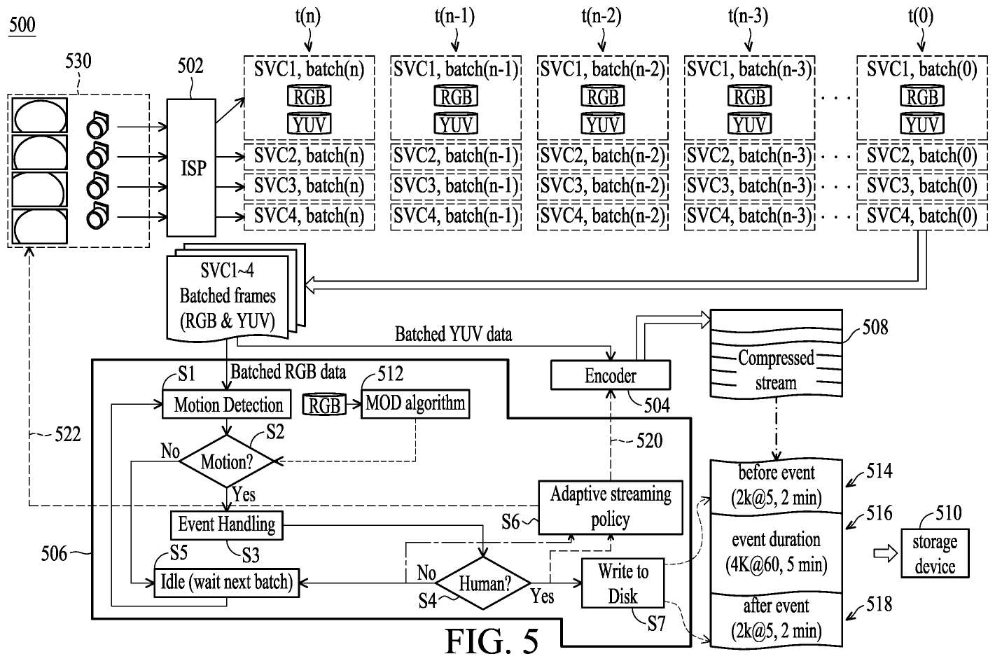

FIG. 5 is a schematic diagram of an electronic device 500 in accordance with some embodiments of the present invention. As shown in FIG. 5, the electronic device 500 includes an image signal processor (ISP) 502, an encoder 504, a processor 506, a DRAM 508, a storage device 510, and cameras 530. The ISP 502 receives a plurality of images from cameras 530. In some embodiments, the cameras 530 include a camera SVC1, a camera SVC2, a camera SVC3, and a camera SVC4, but the present invention does not limit the number of cameras included in the cameras 530. The operation of the ISP 502 may be the same as that of the ISP 402 in FIG. 4, thus the present invention will not repeated herein.

The processor 506 is electrically connected to the ISP 502, executes a moving object detection algorithm 512, and detects that there has been an event based on the images. In detail, the processor 506 receives batched RGB data for event detection and executes motion detection (S1). The moving object detection algorithm 512 executed by the processor 506 determines whether there is motion based on the images received from the cameras 530 (S2). If the processor 506 determines that there is motion (Y), that is, the processor 506 detects motion in the current frame of the images, the processor 506 executes event handling (S3) for subsequent event determination. After that, the processor 506 determines whether the motion was caused by a human (S4). If the processor 506 determines that the motion was caused by a human (Y), the processor 506 determines that there has been an event to execute an adaptive streaming policy (S6), and send a control signal 520 to the encoder 504. If the processor 506 determines that the motion was caused by a human (Y), the processor 506 writes the images from a first predetermined period before the event is detected to a second predetermined period after the event is over into a disk (S7), for example, the storage device 510. In some embodiments, the storage device 510 is a non-volatile memory.

If the processor 506 detects that there is no motion based on the images (N), the processor 506 may enter to an idle mode and wait for next batched RGB data (S5). If the processor 506 determines that the motion was not caused by a human (N), the processor 506 may enter to the idle mode and wait for next batched RGB data (S5). In some embodiments, If the processor 506 determines that the motion was not caused by a human (N), the processor 506 may also execute the adaptive streaming policy (S6), and send the control signal 520 to the encoder 504. After receiving the control signal 520 from the processor 506, the encoder 504 may encode the images with lower resolution and/or lower frame rate based on the control signal 520 when the processor 506 determines that the motion was not caused by the human.

The main difference between FIG. 5 and FIG. 4 is that, when the processor 506 executes the adaptive streaming policy (S6), the processor 506 also sends a control signal 522 to the cameras 530. It is assumed that the cameras 530 originally output the images having a third format, for example, a format with a resolution of 2K and a frame rate of 5 fps. After receiving the control signal 522 from the processor 506, the cameras 530 (including the cameras SVC1, SVC2, SVC3, and SVC4) output the images having a fourth format, for example, a format with a resolution of 4K and a frame rate of 60 fps.

The encoder 504 is electrically connected to the ISP 502 and the processor 506, encodes the images in a first format originally, and encodes the images in a second format after receiving the control signal 520 from the processor 506. For example, the first format may be the format with a resolution of 2K and a frame rate of 5 fps, and the second format may be the format with a resolution of 4K and a frame rate of 60 fps, but the present invention is not limited thereto. In detail, the encoder 504 receives batched YUV data from the ISP 502 for video encoding. After receiving the control signal 520 from the processor 506, the encoder 504 encodes the batched YUV data from using the first format to using the second format. In some embodiments, the encoder 504 all the time stores the batched YUV data corresponding to the images into the DRAM 508. In detail, the encoder 504 may compress the batched YUV data to generate compressed stream, and stores the compressed stream in the DRAM 508.

In some embodiments, when the encoder 504 receives the control signal 520 from the processor 506, the compressed stream corresponding to the images from the first predetermined period before the event is detected to the second predetermined period after the event is over in the DRAM 508 may be stored to the storage device 510. For example, data blocks 514, 516, and 518 may be stored to the storage device 510. The data block 514 includes the compressed stream corresponding to the images from the first predetermined period before the event is detected to the time point when the event is detected. The data block 516 includes the compressed stream corresponding to the images from the time point when the event is detected to the time point when the event is over. The data block 518 include the compressed stream corresponding to the images from the time point when the event is over to the second period after the event is over.

For example, the data block 514 includes the compressed stream corresponding to the images having 2 minutes duration and encoded at a resolution of 2K and a frame rate of 5 fps. The data block 516 includes the compressed stream corresponding to the images having 5 minutes duration and encoded at a resolution of 4K and a frame rate of 60 fps. The data block 518 includes the compressed stream corresponding to the images having 2 minutes duration and encoded at a resolution of 2K and a frame rate of 5 fps. In some embodiments, the DRAM 508 may store the compressed stream corresponding to the images having no longer than 5 minutes duration. The present invention does not limit the number of compressed streams stored in the DRAM 508. If the compressed streams stored by the encoder 504 totally have the duration longer than 5 minutes, the compressed streams stored in the DRAM 508 may be overwritten. That is, the old compressed stream may overwritten by the new compressed stream, but the present invention is not limited thereto. In some embodiments, each of the data blocks 514, 516 and 518 may include one compressed stream or multiple compressed streams. One compressed stream may be decompressed and decoded as a video file for subsequent application.

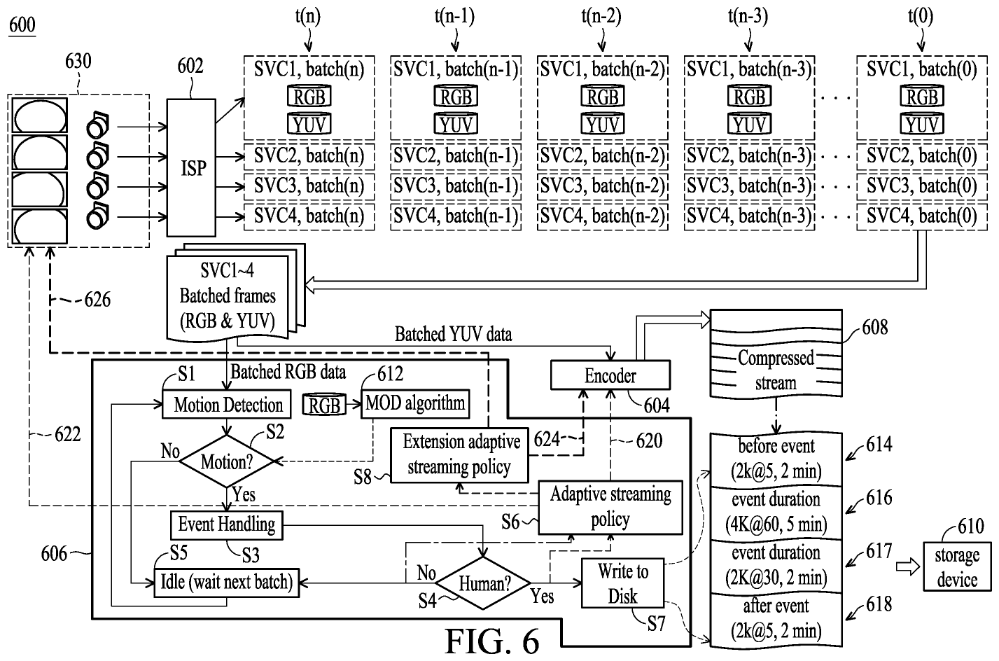

FIG. 6 is a schematic diagram of an electronic device 600 in accordance with some embodiments of the present invention. As shown in FIG. 6, the electronic device 600 includes an image signal processor (ISP) 602, an encoder 604, a processor 606, a DRAM 608, a storage device 610, and cameras 630. The ISP 602 receives a plurality of images from cameras 630. In some embodiments, the cameras 630 include a camera SVC1, a camera SVC2, a camera SVC3, and a camera SVC4, but the present invention does not limit the number of cameras included in the cameras 630. The operation of the ISP 602 may be the same as that of the ISP 402 in FIG. 4, thus the present invention will not repeated herein.

The processor 606 is electrically connected to the ISP 602, executes a moving object detection algorithm 612, and detects that there has been an event based on the images. In detail, the processor 606 receives batched RGB data for event detection and executes motion detection (S1). The moving object detection algorithm 612 executed by the processor 606 determines whether there is motion based on the images received from the cameras 630 (S2). If the processor 606 determines that there is motion (Y), that is, the processor 606 detects motion in the current frame of the images, the processor 606 executes event handling (S3) for subsequent event determination. After that, the processor 606 determines whether the motion was caused by a human (S4). If the processor 606 determines that the motion was caused by a human (Y), the processor 606 determines that there has been an event to execute an adaptive streaming policy (S6), and send a control signal 620 to the encoder 604. If the processor 606 determines that the motion was caused by a human (Y), the processor 606 writes the images from a first predetermined period before the event is detected to a second predetermined period after the event is over into a disk (S7), for example, the storage device 610. In some embodiments, the storage device 610 is a non-volatile memory.

If the processor 606 detects that there is no motion based on the images (N), the processor 606 may enter to an idle mode and wait for next batched RGB data (S5). If the processor 606 determines that the motion was not caused by a human (N), the processor 606 may enter to the idle mode and wait for next batched RGB data (S5). In some embodiments, If the processor 606 determines that the motion was not caused by a human (N), the processor 606 may also execute the adaptive streaming policy (S6), and send the control signal 620 to the encoder 604. After receiving the control signal 620 from the processor 606, the encoder 604 may encode the images with lower resolution and/or lower frame rate based on the control signal 620 when the processor 606 determines that the motion was not caused by the human.

The main difference between FIG. 6 and FIG. 4 is that, when the processor 606 executes the adaptive streaming policy (S6), the processor 506 also sends a control signal 622 to the cameras 630. It is assumed that the cameras 630 originally output the images having a third format, for example, a format with a resolution of 2K and a frame rate of 5 fps. After receiving the control signal 622 from the processor 606, the cameras 630 (including the cameras SVC1, SVC2, SVC3, and SVC4) output the images having a fourth format, for example, a format with a resolution of 4K and a frame rate of 60 fps.

The main difference between FIG. 6 and FIG. 5 is that, when the processor 606 executes the adaptive streaming policy (S6), and also detects that there is an extension event after the event is detected, the processor 608 executes an extension adaptive streaming policy (S8), sends a control signal 624 to the encoder 604, and sends a control signal 626 to the cameras 630. After receiving the control signal 624, the encoder 604 encodes the images with a fifth format, for example, a format with a resolution of 2K and a frame rate of 30, in response to detecting that there has been an extension event after the event is detected. Similarly, when the event is detected, the cameras 630 output the images in the fourth format, for example, a format with a resolution of 4K and a frame rate of 60 fps. After receiving the control signal 626 from the processor 606, the cameras 630 (including the cameras SVC1, SVC2, SVC3, and SVC4) output the images having a sixth format, for example, a format with a resolution of 2K and a frame rate of 30 fps.

In some embodiments, the processor 606 determines that there has been an extension event based on the power consumption of the vehicle, the battery level of the vehicle, the noises around the vehicle, the environment around the vehicle, or a combination thereof, after an event is detected. For example, when the battery level of the vehicle is lower than a threshold after the event is detected, or the temperature around the vehicle is higher than a threshold, the processor 606 determines that there has been an extension event.

The encoder 604 is electrically connected to the ISP 602 and the processor 606, encodes the images in a first format originally, and encodes the images in a second format after receiving the control signal 620 from the processor 606. For example, the first format may be the format with a resolution of 2K and a frame rate of 5 fps, and the second format may be the format with a resolution of 4K and a frame rate of 60 fps, but the present invention is not limited thereto. In detail, the encoder 604 receives batched YUV data from the ISP 602 for video encoding. After receiving the control signal 620 from the processor 606, the encoder 604 encodes the batched YUV data from using the first format to using the second format. In some embodiments, the encoder 604 all the time stores the batched YUV data corresponding to the images into the DRAM 608. In detail, the encoder 604 may compress the batched YUV data to generate compressed stream, and stores the compressed stream in the DRAM 608.

In some embodiments, when the encoder 604 receives the control signal 620 from the processor 606, the compressed stream corresponding to the images from the first predetermined period before the event is detected to the second predetermined period after the event is over in the DRAM 608 may be stored to the storage device 610. For example, data blocks 614, 616, 617, and 618 may be stored to the storage device 610. The data block 614 includes the compressed stream corresponding to the images from the first predetermined period before the event is detected to the time point when the event is detected. The data block 616 includes the compressed stream corresponding to the images from the time point when the event is detected to the time point when the extension event is detected. The data block 617 include the compressed stream corresponding to the images from the time point when the extension event is detected to the time point when the event and the extension event are over. The data block 618 include the compressed stream corresponding to the images from the time point when the event and the extension event are over to the second period after the event and the extension event are over.

For example, the data block 614 includes the compressed stream corresponding to the images having 2 minutes duration and encoded at a resolution of 2K and a frame rate of 5 fps. The data block 616 includes the compressed stream corresponding to the images having 5 minutes duration and encoded at a resolution of 4K and a frame rate of 60 fps. The data block 617 includes the compressed stream corresponding to the images having 2 minutes duration and encoded at a resolution of 2K and a frame rate of 30 fps. The data block 618 includes the compressed stream corresponding to the images having 2 minutes duration and encoded at a resolution of 2K and a frame rate of 5 fps. In some embodiments, the DRAM 608 may store the compressed stream corresponding to the images having no longer than 5 minutes duration. The present invention does not limit the number of compressed streams stored in the DRAM 608. If the compressed streams stored by the encoder 604 totally have the duration longer than 5 minutes, the compressed streams stored in the DRAM 608 may be overwritten. That is, the old compressed stream may overwritten by the new compressed stream, but the present invention is not limited thereto. In some embodiments, each of the data blocks 614, 616, 617 and 618 may include one compressed stream or multiple compressed streams. One compressed stream may be decompressed and decoded as a video file for subsequent application.

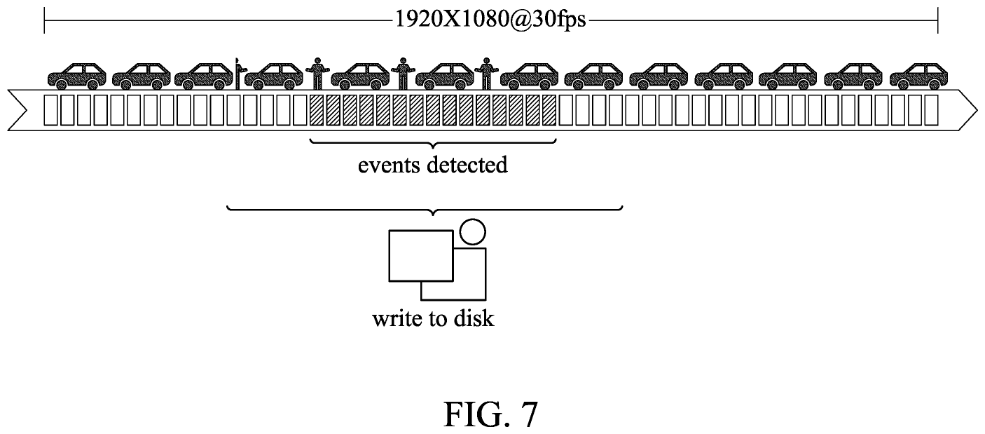

FIG. 7 is a schematic diagram of a method for consistent streaming in the prior art. As shown in FIG. 7, the prior art executes the method for consistent streaming. For example, the prior art always encodes the images from the cameras in a format with a resolution of 1920×1080 (2K) and a frame rate of 30 fps no matter whether an event is detected. If the prior art detects that there has been an event as shown in FIG. 7, the prior art stores onto a disk the images from a period including the four frames before the detection of the event to a period including the four frames after the event is over.

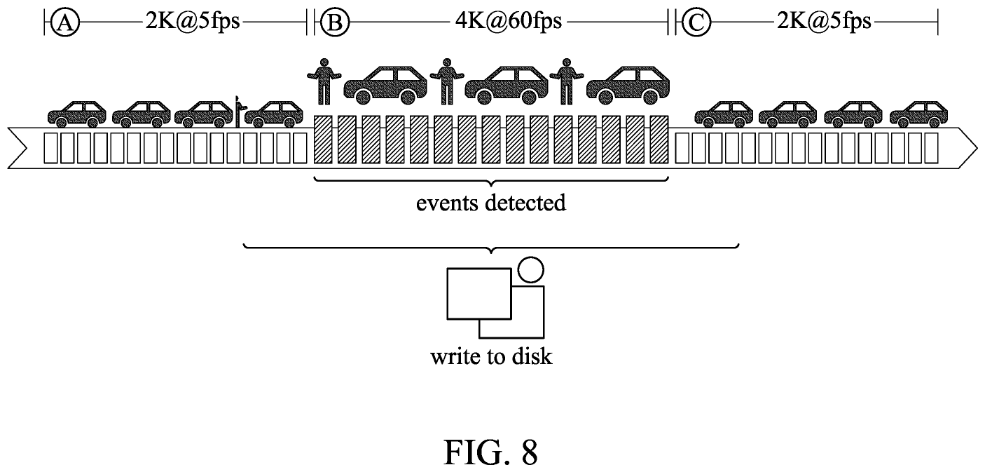

FIG. 8 is a schematic diagram of a method for adaptive streaming in accordance with some embodiments of the present invention. As shown in FIG. 8, the method for adaptive streaming of the present invention encodes the images from the cameras in a format with a resolution of 2K and the frame rate of 5 fps in period A, which is the period before the event is detected. The method for adaptive streaming of the present invention encodes the images from the cameras in a format with a resolution of 4K and a frame rate of 60 fps in period B, which is the period when the event is detected. The method for adaptive streaming of the present invention recover to encode the images from the cameras in the format with a resolution of 2K and a frame rate of 5 fps in period C, which is the period after the event is over. The method for adaptive streaming of the present invention stores the images from a period including four frames before the event is detected to a period including four frames after the event is over into a disk.

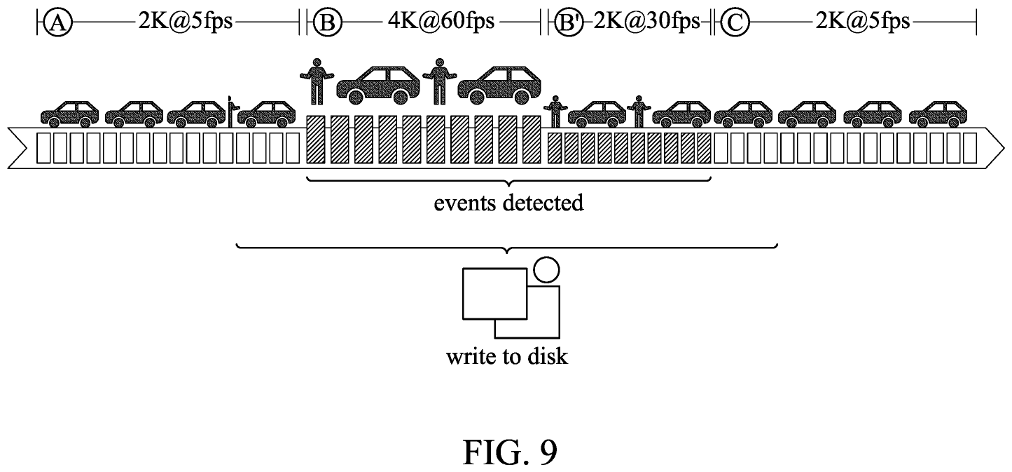

FIG. 9 is a schematic diagram of a method for adaptive streaming in accordance with some embodiments of the present invention. As shown in FIG. 9, the method for adaptive streaming of the present invention encodes the images from the cameras in a format with a resolution of 2K and a frame rate of 5 fps in period A, which is the period before the event is detected. The method for adaptive streaming of the present invention encodes the images from the cameras in a format with a resolution of 4K and a frame rate of 60 fps in period B, which is the period when the event is detected. The method for adaptive streaming of the present invention recover to encode the images from the cameras in the format with a resolution of 2K and a frame rate of 30 fps in period B′, which is the period when the extension event is detected after the event is detected. The method for adaptive streaming of the present invention recover to encode the images from the cameras in the format with a resolution of 2K and a frame rate of 5 fps in period C, which is the period after the event and the extension event are over. The method for adaptive streaming of the present invention stores the images from a period including four frames before the event is detected to a period including four frames after the event and the extension event are over into a disk.

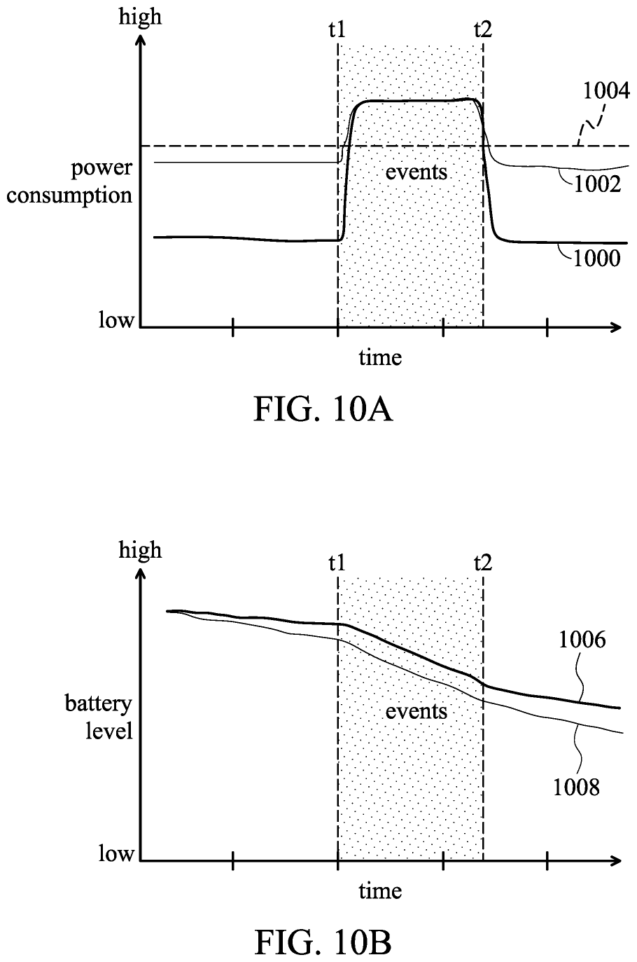

FIG. 10A is a comparison diagram of power consumption between the method for adaptive streaming of the present invention and the method for consistent streaming in the prior art. As shown in FIG. 10A, a curve 1000 indicates the power consumption applying to the method for adaptive streaming of the present invention. A curve 1002 indicates the power consumption applying to the method for consistent streaming in the prior art. A line 1004 indicates a threshold for average power consumption required by customers. The higher the encoding quality is, the larger the power consumption is. Before time point t1, the method for adaptive streaming of the present invention encodes the images in a format having lower quality than that of the prior art. At time point t1 when an event is detected, the method for adaptive streaming of the present invention encodes the images in a format having the same quality as that of the prior art between time points t1 and t2. After the event is over at time point t2, the method for adaptive streaming of the present invention encodes the images in a format having lower quality than that of the prior art. That is, the difference between the line 1004 and the average power consumption applying to the method for adaptive streaming of the present invention is larger than that between the line 1004 and the average power consumption applying to the method for consistent streaming in the prior art. The method for adaptive streaming of the present invention is more power saving than the method for consistent streaming in the prior art.

FIG. 10B is a comparison diagram of a battery level loss between the method for adaptive streaming of the present invention and the method for consistent streaming in the prior art corresponding to FIG. 10A. As shown in FIG. 10B, a curve 1006 indicates the battery level loss applying to the method for adaptive streaming of the present invention. A curve 1008 indicates the battery level loss applying to the method for consistent streaming in the prior art. No matter before the event is detected (before time point t1), or during the event (between time points t1 and t2), or after the event is over (after time point t2), the battery level loss applying to the method for adaptive streaming of the present invention is always lighter than that applying to the method for consistent streaming in the prior art. The method for adaptive streaming of the present invention is more power saving than the method for consistent streaming in the prior art.

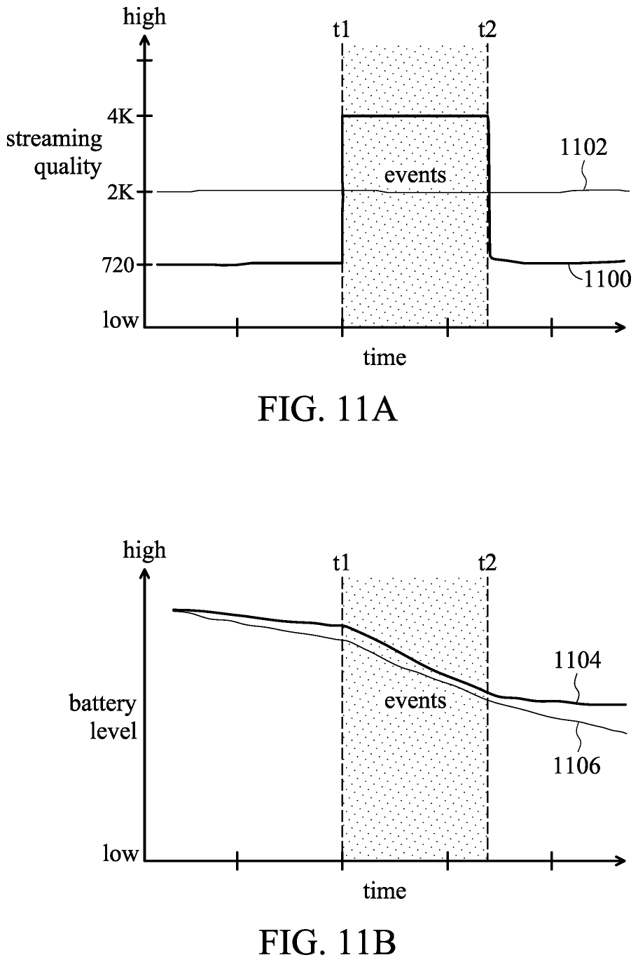

FIG. 11A is a comparison diagram of a streaming quality between the method for adaptive streaming of the present invention and the method for consistent streaming in the prior art. As shown in FIG. 11A, a curve 1100 indicates the power consumption applying to the method for adaptive streaming of the present invention. A curve 1102 indicates the power consumption applying to the method for consistent streaming in the prior art. Before time point t1, the method for adaptive streaming of the present invention encodes the images in a format having lower quality than that of the prior art. At time point t1 when an event is detected, the method for adaptive streaming of the present invention encodes the images in a format having higher quality than that of the prior art between time points t1 and t2. After the event is over at time point t2, the method for adaptive streaming of the present invention encodes the images in a format having lower quality than that of the prior art. Since the period between time points t1 and t2 is shorter than the period before time point t1 plus the period after time point t2, the average power consumption applying to the method for adaptive streaming of the present invention is less than that applying to the method for consistent streaming in the prior art. The method for adaptive streaming of the present invention is more power saving than the method for consistent streaming in the prior art.

FIG. 11B is a comparison diagram of a battery level loss between the method for adaptive streaming of the present invention and the method for consistent streaming in the prior art corresponding to FIG. 11A. As shown in 11B, a curve 1104 indicates the battery level loss applying to the method for adaptive streaming of the present invention. A curve 1106 indicates the battery level loss applying to the method for consistent streaming in the prior art. No matter before the event is detected (before time point t1), or during the event (between time points t1 and t2), or after the event is over (after time point t2), the battery level loss applying to the method for adaptive streaming of the present invention is always lighter than that applying to the method for consistent streaming in the prior art. The method for adaptive streaming of the present invention is more power saving than the method for consistent streaming in the prior art.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for adaptive streaming, comprising:
receiving a plurality of images from at least one camera;
encoding the images in a first format;
detecting that there has been an event based on the images;
encoding the images in a second format in response to detecting that there has been an event; and
storing the images into a non-volatile memory,
wherein the images encoded in the second format are higher quality than the images encoded in the first format.

2. The method as claimed in claim 1, wherein the step of encoding images from the first format to the second format comprises:
encoding the images by changing resolution, frame rate, or both, of the images.

3. The method as claimed in claim 1, further comprising:
recovering the images to encode them in the first format after the event is over.

4. The method as claimed in claim 1, further comprising:
storing the images encoded in the first format into a volatile memory before detecting that there has been an event; and
storing the images encoded in the first format into the volatile memory after the event is over;
wherein the images are from a first predetermined period before the event is detected to a second predetermined period after the event is over.

5. The method as claimed in claim 1, wherein the images received from the at least one camera originally have a third format, the method further comprising:
receiving the images that are in a fourth format from the at least one camera in response to detecting that there has been an event;
wherein the images in the fourth format are a higher quality than the images in the third format.

6. The method as claimed in claim 5, further comprising:
detecting that there is an extension event after the event is detected;
encoding the images with a fifth format in response to detecting that there has been an extension event after the event is detected;
wherein the images encoded in the fifth format are lower quality than the images encoded in the second format.

7. The method as claimed in claim 6, wherein the step of detecting that there has been an extension event after the event is detected comprises:
determining that there has been an extension event based on at least one of power consumption of a vehicle, a battery level of the vehicle, noises around the vehicle, and environment around the vehicle after the event is detected.

8. The method as claimed in claim 6, further comprising:
receiving the images that are in a sixth format from the at least one camera in response to detecting that there has been an extension event;
wherein the images in the sixth format are lower quality than the images in the fourth format.

9. An electronic device, comprising:
an image signal processor (ISP), configured to receive a plurality of images from at least one camera;
a processor, electrically connected to the ISP, configured to execute a moving object detection algorithm, and detect that there has been an event based on the images;
an encoder, electrically connected to the ISP and the processor, configured to encode the images in a first format, and encode the images in a second format when the processor detects that that there has been an event;
wherein the images encoded in the second format are higher quality than the images encoded in the first format.

10. The electronic device as claimed in claim 9, wherein the encoder encodes images from the first format to the second format by changing the resolution, frame rate, or both, of the images.

11. The electronic device as claimed in claim 9, wherein the encoder recovers the images to encode the images in the first format after the event is over.

12. The electronic device as claimed in claim 9, wherein the processor stores the images encoded in the first format into a volatile memory before detecting that there has been an event, and stores the images encoded in the first format into the volatile memory after the event is over; wherein the processor stores the images from a first predetermined period before the event is detected to a second predetermined period after the event is over into a non-volatile memory.

13. The electronic device as claimed in claim 9, wherein the images received from the at least one camera originally have a third format; the ISP receives the images that are in a fourth format from the at least one camera when the processor detects that there has been an event; the images in the fourth format are higher quality than the images in the third format.

14. The electronic device as claimed in claim 13, wherein the processor detects that there is an extension event after the event is detected; the encoder encodes the images in a fifth format when the processor detects that there has been an extension event after the event is detected; the images encoded in the fifth format are lower quality than the images encoded in the second format.

15. The electronic device as claimed in claim 14, wherein the processor determines that there has been an extension event based on at least one of power consumption of a vehicle, a battery level of the vehicle, noises around the vehicle, and environment around the vehicle after the event is detected.

16. The electronic device as claimed in claim 14, wherein the ISP receives the images that are in a sixth format from the at least one camera when the processor detects that there has been an extension event; the images in the sixth format are lower quality than the images in the fourth format.
